(19) United States
(12) Patent Application Publication
(10) Pub. No.: US 2013/0314320 A1
(43) Pub. Date: Nov. 28, 2013

(54) METHOD OF CONTROLLING THREE-DIMENSIONAL VIRTUAL CURSOR BY USING PORTABLE ELECTRONIC DEVICE

(71) Applicants: Jae In HWANG, Seoul (KR); Ig Jae KIM, Seoul (KR); Sang Chul AHN, Seoul (KR); Heedong KO, Seoul (KR)

(72) Inventors: Jae In HWANG, Seoul (KR); Ig Jae KIM, Seoul (KR); Sang Chul AHN, Seoul (KR); Heedong KO, Seoul (KR)

(21) Appl. No.: 13/727,077

(22) Filed: Dec. 26, 2012

(30) Foreign Application Priority Data
May 23, 2012 (KR) 10-2012-0054944

(51) Int. Cl. G06F 3/0346

(52) U.S. Cl. CPC G06F 3/0346
USPC 345/158

(57) ABSTRACT

A method of controlling a three-dimensional virtual cursor (3D) by using a portable electronic device, the method including: sensing at least one of a movement and a touch input of a portable electronic device through a sensor mounted in the portable electronic device; and converting the sensed at least one of the movement and the touch input of the portable electronic device into a cursor control signal for controlling an operation of a cursor in a 3D space to output the cursor control signal. According to the method, a 3D virtual cursor may be conveniently controlled without a location or time limit by using a portable electronic device which a user carries.

### CROSS-REFERENCE TO RELATED PATENT APPLICATION

This application claims the benefit of Korean Patent Application No. 10-2012-0054944, filed on May 23, 2012, in the Korean Intellectual Property Office, the disclosure of which is incorporated herein in its entirety by reference.

### BACKGROUND OF THE INVENTION

1. Field of the Invention

The present invention relates to a method of controlling a three-dimensional (3D) virtual cursor, and more particularly, to a method of controlling a cursor in a 3D virtual space based on a movement or touch input of a portable electronic device.

2. Description of the Related Art

Technologies for input devices such as a mouse or a touch have been continuously developed and evolved, but long-term use of input devices such as a mouse or a touch may cause harmful side effects such as overstrain of a user's wrist and fingers. In particular, input devices such as a mouse or a touch are not suitable for a ubiquitous/mobile computing field such as a digital information display (DID) or internet protocol television (IPTV) that is being actively used recently and can be accessed to computing resources anytime and anywhere. Touch screens were developed in order to overcome the limitations of input devices such as a mouse or a touch, but the touch screens also have limitations and in particular, have difficulties in terms of manufacture of a large screen and cost.

When considering a recent trend to switch from a two-dimensional (2D) display to a three-dimensional (3D) display, need for an input interface technology that may perform 3D interaction is increasing.

A representative 3D interaction technology is a technology using a commercial 3D tracker. Interaction in 3D environment is possible by using a tracker having an accurate sensor that senses a minute movement of a device. However, the technology using a commercial 3D tracker is inefficient in terms of cost. An accurate 3D tracker is expensive, and a user should purchase a tracker whether the tracker is expensive or inexpensive.

In addition, the technology using a commercial 3D tracker may operate under conditions that 3D environment and environment for interaction are configured. That is, 3D interaction is possible only at a place where a tracker is installed. Due to these constraints, the technology using a commercial 3D tracker has limitations in popular use.

Accordingly, a technology that may more easily and popularly implement 3D interaction environment by using a portable electronic device which a user carries is required.

### SUMMARY OF THE INVENTION

The present invention provides a method of controlling a three-dimensional (3D) virtual cursor, which controls a cursor in a 3D virtual space based on a movement or touch input of a portable electronic device.

Technical aspects of the present invention are not limited to the above, and other technical aspects not described herein will be clearly understood by one of ordinary skill in the art from the disclosure below.

According to an aspect of the present invention, there is provided a method of controlling a three-dimensional (3D) virtual cursor, the method including: sensing at least one of a movement and a touch input of a portable electronic device through a sensor mounted in the portable electronic device; and converting the sensed at least one of the movement and the touch input of the portable electronic device into a cursor control signal for controlling an operation of a cursor in a 3D space to output the cursor control signal.

The sensor may include an inertial measurement unit (IMU), which comprises at least one of a gyro sensor, an acceleration sensor, and a magnetic field sensor, and a touch sensor.

Operations of the cursor may include at least one of a movement of the cursor, a selection of a 3D virtual object indicated by the cursor, a release of a selection of a 3D virtual object indicated by the cursor, a movement of a 3D virtual object indicated by the cursor, a rotation of a 3D virtual object indicated by the cursor, a size change of a 3D virtual object indicated by the cursor, and a change of a viewpoint of a 3D virtual space that is presently displayed.

The converting of the sensed at least one of the movement and the touch input may include combining the sensed movement of the portable electronic device with the sensed touch input of the portable electronic device to convert a combined result into the cursor control signal.

According to another aspect of the present invention, there is provided a computer-readable recording medium having recorded thereon a program for executing a method of controlling a 3D virtual cursor, the method including: sensing at least one of a movement and a touch input of a portable electronic device through a sensor mounted in the portable electronic device; and converting the sensed at least one of the movement and the touch input of the portable electronic device into a cursor control signal for controlling an operation of a cursor in a 3D space to output the cursor control signal.

According to the method of controlling a 3D virtual cursor, a 3D virtual cursor may be conveniently controlled without a location or time limit by using a portable electronic device which a user carries.

In addition, the method of controlling a 3D virtual cursor may be widely applied to various fields. For example, the method of controlling a 3D virtual cursor may be used for watching a 3D television at home. Also, the method of controlling a 3D virtual cursor may be used for a 3D presentation at companies, and in this case, a visual understanding is promoted, and thus, the content of a presentation may be more easily conveyed to an audience. Furthermore, if the method of controlling a 3D virtual cursor is applied to a prototyping process, which is one of processes of manufacturing products at factories, a test of the products may be more safely and efficiently performed.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of controlling a three-dimensional (3D) virtual cursor by using a portable electronic device, according to an embodiment of the present invention;

FIGS. 2A and 2B are diagrams illustrating control commands that are provided in the method of controlling a 3D virtual cursor;

FIG. 3 is a flowchart illustrating a process of selecting a 3D virtual object according to a movement or touch input of a portable electronic device in a 3D virtual space, according to the method of controlling a 3D virtual cursor;

FIG. 4 is a flowchart illustrating a process of controlling a 3D virtual object selected according to a movement or touch input of a portable electronic device, according to the method of controlling a 3D virtual cursor; and

FIGS. 5A through 5D are diagrams illustrating 3D virtual spaces that are displayed according to a movement or touch input of a portable electronic device, according to some embodiments of the present invention.

### DETAILED DESCRIPTION OF THE INVENTION

The contents below illustrate only the principle of the present invention. Therefore, although not clearly described or shown in the specification, one of ordinary skill in the art may implement the principle of the present invention and invent various apparatuses included in the spirit and scope of the present invention. In addition, it should be understood in principle that all conditional terms and embodiments listed in the specification are obviously intended only for the purpose to understand the spirit of the present invention and are not limited to the specifically listed embodiments and states. In addition, it should be understood that all detailed descriptions listing not only the principle, views and embodiments of the present invention but also specific embodiments are intended to include these structural and functional equivalents. In addition, it should be understood that these equivalents include not only currently known equivalents but also equivalents to be developed in the future, i.e., all elements invented to perform the same function regardless of their structures.

Therefore, functions of various elements shown in the drawings, which include a processor or a function block shown as a similar concept, may be provided by using not only exclusive hardware but also software-executable hardware in association with proper software. When the functions are provided by a processor, the functions may be provided by a single exclusive processor, a single shared processor, or a plurality of individual processors, some of which can be shared. In addition, it should be understood that the explicit use of the term “processor”, “controller”, or other similar device should not be considered as exclusively indicating software-executable hardware and may implicitly include Digital Signal Processor (DSP) hardware, a Read Only Memory (ROM) for storing software, a Random Access Memory (RAM), and a non-volatile storage device without any limitation. Other well-known public use hardware may be included.

The objectives, characteristics, and merits of the present invention will be described in detail by explaining embodiments of the invention with reference to the attached drawings. In the following description, well-known functions or constructions are not described in detail since they would obscure the invention.

In the specification, when a certain part “includes” a certain component, this indicates that the part may further include another component instead of excluding another component unless there is no different disclosure.

Hereinafter, the present invention will be described more fully with reference to the accompanying drawings, in which exemplary embodiments of the invention are shown. Expressions such as “at least one of,” when preceding a list of elements, modify the entire list of elements and do not modify the individual elements of the list.

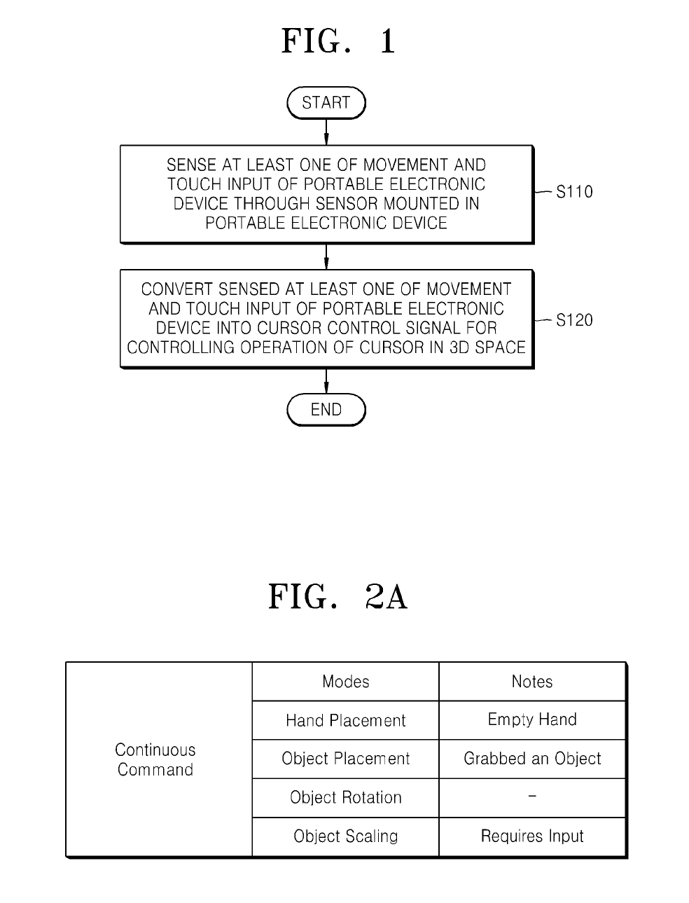

FIG. 1 is a flowchart illustrating a method of controlling a three-dimensional (3D) virtual cursor by using a portable electronic device, according to an embodiment of the present invention.

Referring to FIG. 1, first, a movement or touch input of a portable electronic device is sensed through a sensor mounted in the portable electronic device (operation S110).

A typical portable electronic device according to the current embodiment is a smartphone. The smartphone is a portable electronic communication device having a high-performance information processing capability of a desktop or laptop level, and has many sensors and thus may accurately sense a movement or touch input of the smartphone itself. In addition, the smartphone may sufficiently convert the sensed movement or touch input into a cursor control signal by having a high-performance information processing capability.

However, the portable electronic device according to the current embodiment is not limited to the smartphone, and may be any portable electronic device that includes a predetermined sensor, a predetermined information processing capability, and a predetermined communication module.

A sensor according to the current embodiment may include an inertial sensor, namely, an inertial measurement unit (IMU) that may recognize a rotation movement in any one of the directions of three axes of the portable electronic device, and a touch sensor that may recognize a touch input in any one of the directions of two axes of the portable electronic device.

The inertial sensor may include at least one of a gyro sensor, an acceleration sensor, and a magnetic field sensor.

At least one of the movement and touch input of the portable electronic device, sensed in operation S110, is converted into a cursor control signal for controlling an operation of a cursor in a 3D space (operation S120).

For example, if in operation S110, operations of a 3D virtual cursor are sensed with respect to the rotation movement in any one of the directions of the three axes and the touch input in any one of the directions of the two axes, simply adding rotation movements corresponding to the directions of the three axes and touch inputs corresponding to the directions of the two axes results only five degrees of freedom, and thus may not be sufficient for mapping all the operations of the 3D virtual cursor.

Accordingly, it may be more efficient to map a result obtained by combining the rotation movement in any one of the directions of the three axes with the touch input in any one of the directions of the two axes to the operations of the 3D virtual cursor. To this end, in operation S120, it is more preferable to combine the movement of the portable electronic device with the touch input thereof, the movement and touch input sensed in operation 110, and to convert a combined result into a cursor control signal.

The operations of the 3D virtual cursor may include a movement of the 3D virtual cursor, a selection of a 3D virtual object indicated by the 3D virtual cursor, a movement of a 3D virtual object indicated by the 3D virtual cursor, a rotation of a 3D virtual object indicated by the 3D virtual cursor, a size change of a 3D virtual object indicated by the 3D virtual cursor, and a change of a viewpoint of a 3D virtual space that is presently displayed.

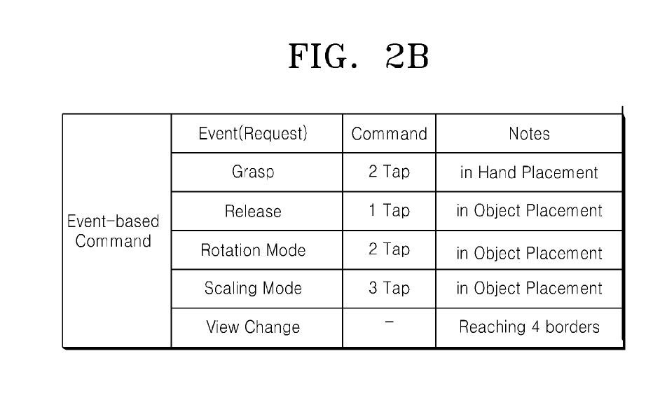

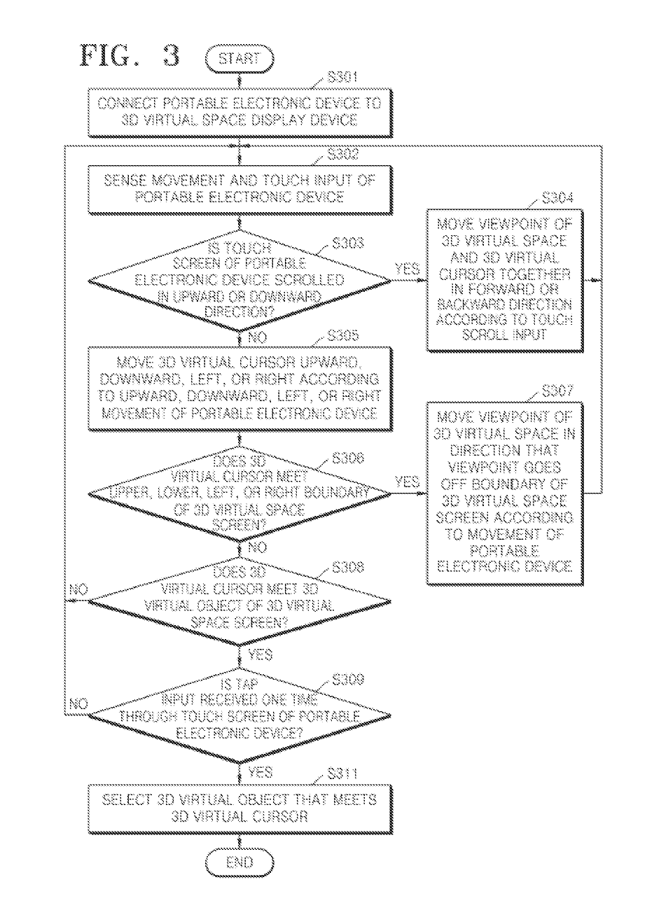

FIGS. 2A and 2B are diagrams illustrating control commands that are provided in the method of controlling a 3D virtual cursor according to the above embodiment of the present invention.

A continuous command illustrated in FIG. 2A indicates a control command in a state where a movement of the portable electronic device is recognized as a continuous input value, and may include “Hand Placement”, “Object Placement”, “Object Rotation”, and “View change”.

“Hand Placement” may be displayed as an empty hand-shaped icon, and denotes a command that recognizes a continuous movement of the portable electronic device as continuous moving coordinate values of the 3D space and moves a cursor in three-dimensions according to the continuous movement of the portable electronic device in a state in which the current cursor has not selected a 3D virtual object.

“Object Placement” may be displayed as a hand-shaped icon that that holds a 3D virtual object, and denotes a command that recognizes a continuous movement of the portable electronic device as continuous moving coordinate values of the 3D space and moves the position of the 3D virtual object three-dimensionally according to the continuous movement of the portable electronic device in a state in which the current cursor has selected a predetermined 3D virtual object positioned in the 3D virtual space.

“Object Rotation” may be displayed as a hand-shaped icon that holds a 3D virtual object like “Object Placement”, and denotes a command that recognizes a continuous rotation direction and rotation angle of the portable electronic device as a continuous rotation direction and rotation angle of the 3D space and rotates the shape of the 3D virtual object three-dimensionally according to a rotation of the portable electronic device in a state in which the current cursor has selected a predetermined 3D virtual object positioned in the 3D virtual space.

“Object Scaling” may be displayed as a hand-shaped icon that holds a 3D virtual object like “Object Placement”, and denotes a command that recognizes a touch input (for example, a touch scroll in any one of the directions of two axes) for the portable electronic device as a change rate of the size of the 3D virtual object and enlarges or reduces the size of the 3D virtual object at a constant rate according to the extent of the touch input for the portable electronic device in a state in which the current cursor has selected a predetermined 3D virtual object positioned in the 3D virtual space.

“View Change” denotes a command that recognizes a continuous movement of the portable electronic device at upper, lower, left, and, right boundaries of a 3D virtual space, which is presently displayed, as continuous moving coordinate values of a viewpoint for the 3D space and moves a viewpoint of a display screen for the 3D virtual space three-dimensionally according to the continuous movement of the portable electronic device. In some implementation examples, a viewpoint of the 3D space may be moved together with a 3D virtual cursor or a presently selected object according to a touch scroll input of the portable electronic device.

An event-based command illustrated in FIG. 2B indicates a command that changes a state, in which any one of the continuous commands illustrated in FIG. 2A is performed according to a movement or touch input of the portable electronic device, into a state in which another of the continuous commands is performed. The event-based command may include “Grasp”, “Release”, “Rotation Mode”, “Scaling Mode”, and “View change”. “Grasp” denotes a selection of a 3D virtual object, “Release” denotes a deselection of a 3D virtual object, and “Rotation Mode” denotes a switch to a rotation mode of a 3D virtual object. “Scaling Mode” denotes a switch to a change mode of the size of a 3D virtual object, and “View change” denotes a switch to a change mode of a viewpoint of a 3D virtual space.

The continuous command illustrated in FIG. 2A and the event-based command illustrated in FIG. 2B are only examples for convenience of explanation, and the present invention is not limited thereto.

FIG. 3 is a flowchart illustrating a process of selecting a 3D virtual object according to a movement or touch input of a portable electronic device in a 3D virtual space, according to the method of controlling a 3D virtual cursor.

First, a portable electronic device that performs a function of a user input unit is connected to a 3D virtual space display device, which displays a 3D virtual space to a user, through a wireless network (operation S301).

Next, a movement and touch input of the portable electronic device is sensed using an inertial sensor and a touch sensor, mounted in the portable electronic device (operation S302).

When the touch input sensed in operation S302 is a touch scroll input for scrolling a touch screen of the portable electronic device in an upward or downward direction (operation S303), a viewpoint of the 3D virtual space and a 3D virtual cursor are moved together in a forward or backward direction according to the touch scroll input (operation S304).

Alternatively, a 3D virtual cursor is moved upward, downward, left, or right according to an upward, downward, left, or right movement of the portable electronic device, sensed in operation S302 (operation S305).

When the 3D virtual cursor moved in operation S305 meets an upper, lower, left, or right boundary of a 3D virtual space screen (operation S306), the viewpoint of the 3D virtual space may be moved in a direction that the viewpoint jumpes over the boundary of the 3D virtual space screen according to a movement of the portable electronic device (operation S307).

Alternately, when the 3D virtual cursor moved in operation S305 meets a 3D virtual object of the 3D virtual space screen (operation S308), the 3D virtual object is selected (operation S311) when a tap input is continuously received one time through a touch screen of the portable electronic device (operation S309).

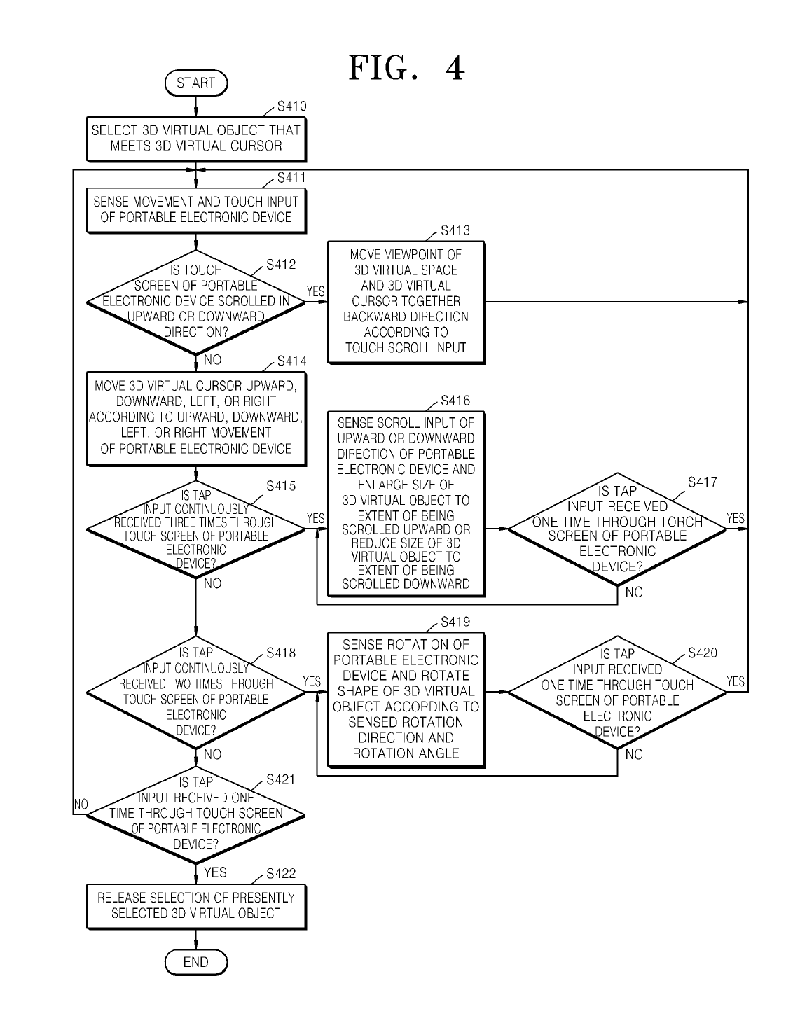

FIG. 4 is a flowchart illustrating a process of controlling a 3D virtual object selected according to a movement or touch input of a portable electronic device, according to the method of controlling a 3D virtual cursor.

First, a 3D virtual object that meets a 3D virtual cursor is selected (operation S410). Operation S410 of selecting the 3D virtual object may be performed according to the selection operation (operations S309 and S311) illustrated in FIG. 3. However, this is only an example for convenience of explanation, and the present invention is not limited thereto.

Next, a movement and touch input of the portable electronic device is sensed using an inertial sensor and a touch sensor, mounted in the portable electronic device (operation S411).

When the touch input sensed in operation S411 is a touch scroll input for scrolling a touch screen of the portable electronic device in an upward or downward direction (operation S412), the 3D virtual object selected in operation S410 is moved in a forward or backward direction together with a viewpoint of a 3D virtual space according to the touch scroll input (operation S413).

Alternatively, the 3D virtual object selected in operation S410 is moved upward, downward, left, or right according to an upward, downward, left, or right movement of the portable electronic device, sensed in operation S401 (operation S414).

When a tap input is continuously received three times through the touch screen of the portable electronic device in a state in which the 3D virtual object has been selected (S415), a mode is switched to the “Scaling Mode” and then a scroll input of an upward or downward direction of the portable electronic device is sensed (operation S416). In this case, the size of the 3D virtual object may be enlarged to the extent of being scrolled upward when the sensed scroll input is an upward scroll, and may be reduced to the extent of being scrolled downward when the sensed scroll input is an downward scroll (operation S416). When a tap input is received one time through the torch screen of the portable electronic device while controlling the 3D virtual object in the “Scaling Mode” of operation S416 (operation S417), the “Scaling Mode” is turned off and it is possible to control the 3D virtual object again according to a movement and touch input of the portable electronic device.

When a tap input is continuously received two times through the touch screen of the portable electronic device in a state in which the 3D virtual object has been selected (S418), a mode is switched to the “Rotation Mode” and then a rotation of the portable electronic device is sensed (operation S419). Then, the shape of the 3D virtual object may be rotated according to a sensed rotation direction and a rotation angle (operation S419). When a tap input is received one time through the touch screen of the portable electronic device while controlling the 3D virtual object in the “Rotation Mode” of operation S419 (operation S420), the “Rotation Mode” is turned off and it is possible to control the 3D virtual object again according to a movement and touch input of the portable electronic device.

When a tap input is received one time through the touch screen of the portable electronic device in a state in which the 3D virtual object has been selected (operation S421), the selection of the presently selected 3D virtual object may be released (operation S422).

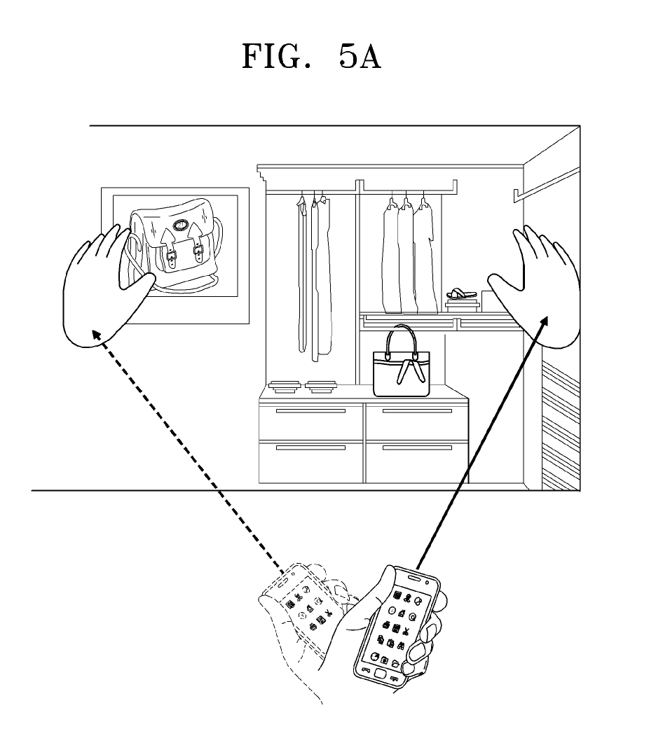

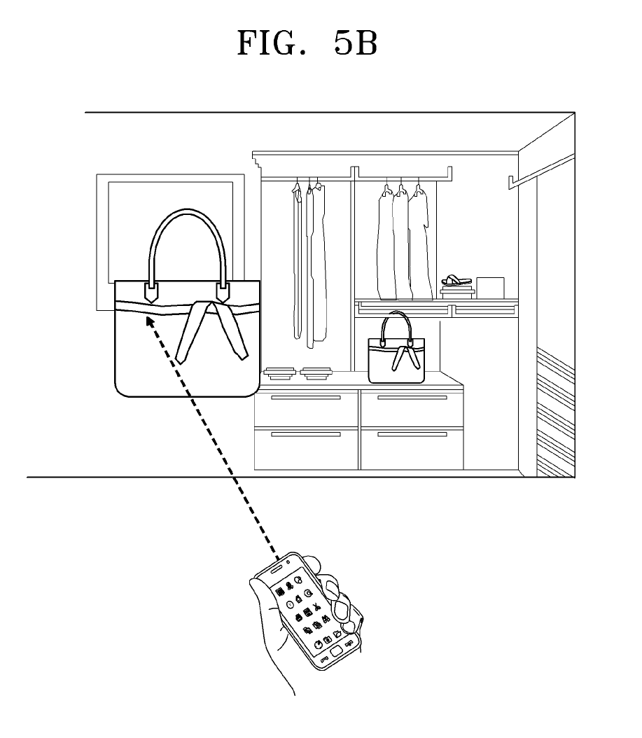

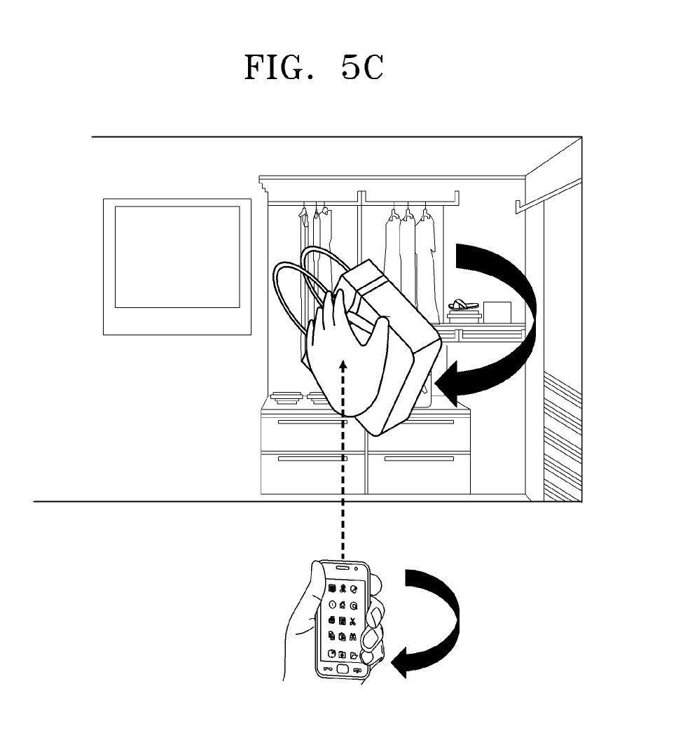

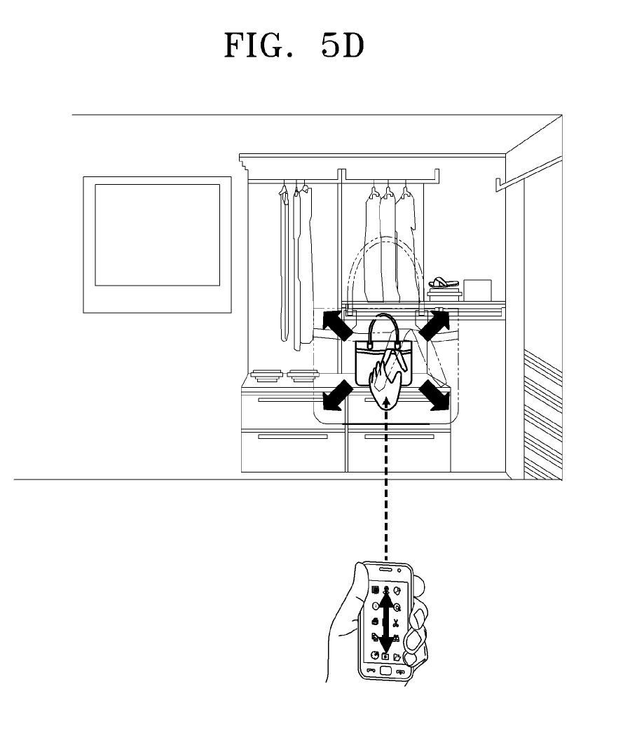

FIGS. 5A through 5D are diagrams illustrating 3D virtual spaces that are displayed according to a movement or touch input of a portable electronic device, according to some embodiments of the present invention.

FIG. 5A illustrates a 3D virtual space that is displayed when moving a 3D virtual cursor in the “Hand Placement” mode.

FIG. 5B illustrates a 3D virtual space that is displayed when moving an object selected by a 3D virtual cursor in the “Object Placement” mode.

FIG. 5C illustrates a 3D virtual space that is displayed when rotating an object selected by a 3D virtual cursor in the “Object Rotation” mode.

FIG. 5D illustrates a 3D virtual space that is displayed when changing the size of an object selected by a 3D virtual cursor in the “Object Scaling” mode.

According to the method of controlling a 3D virtual cursor, a 3D virtual cursor may be conveniently controlled without a location or time limit by using a portable electronic device which a user carries.

In addition, the method of controlling a 3D virtual cursor may be widely applied to various fields. For example, the method of controlling a 3D virtual cursor may be used for watching a 3D television at home. Also, the method of controlling a 3D virtual cursor may be used for a 3D presentation at companies, and in this case, a visual understanding is promoted, and thus, the content of a presentation may be more easily conveyed to an audience. Furthermore, if the method of controlling a 3D virtual cursor is applied to a prototyping process, which is one of processes of manufacturing products at factories, a test of the products may be more safely and efficiently performed.

The method of controlling a 3D virtual cursor according to the present invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and the like. The computer-readable recording medium can also be distributed over network coupled computer systems so that the computer-readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a three-dimensional (3D) virtual cursor, the method comprising:
sensing at least one of a movement and a touch input of a portable electronic device through a sensor mounted in the portable electronic device; and
converting the sensed at least one of the movement and the touch input of the portable electronic device into a cursor control signal for controlling an operation of a cursor in a 3D space to output the cursor control signal.

2. The method of claim 1, wherein the sensor comprises an inertial measurement unit (IMU), which comprises at least one of a gyro sensor, an acceleration sensor, and a magnetic field sensor, and a touch sensor.

3. The method of claim 1, wherein operations of the cursor comprises at least one of a movement of the cursor, a selection of a 3D virtual object indicated by the cursor, a release of a selection of a 3D virtual object indicated by the cursor, a movement of a 3D virtual object indicated by the cursor, a rotation of a 3D virtual object indicated by the cursor, a size change of a 3D virtual object indicated by the cursor, and a change of a viewpoint of a 3D virtual space that is presently displayed.

4. The method of claim 1, wherein the converting of the sensed at least one of the movement and the touch input comprises combining the sensed movement of the portable electronic device with the sensed touch input of the portable electronic device to convert a combined result into the cursor control signal.

5. A computer-readable recording medium having recorded thereon a program for executing a method of controlling a 3D virtual cursor, the method comprising:
sensing at least one of a movement and a touch input of a portable electronic device through a sensor mounted in the portable electronic device; and
converting the sensed at least one of the movement and the touch input of the portable electronic device into a cursor control signal for controlling an operation of a cursor in a 3D space to output the cursor control signal.
